(19) United States
(12) Patent Application Publication
(10) Pub. No.: US 2022/0383114 A1
(43) Pub. Date: Dec. 1, 2022

(54) LOCALIZATION THROUGH MANIFOLD LEARNING AND OPTIMAL TRANSPORT

(71) Applicant: Qualcomm Incorporated, San Diego, CA (US)

(72) Inventors: Farhad Ghazvinian Zanjani, Almere (NL); Ilia Karmanov, Amsterdam (NL); Daniel Hendricus Franciscus Dijkman, Haarlem (NL); Hanno Ackermann, Hilversum (NL); Simone Merlin, San Diego, CA (US); Brian Michael Buesker, San Diego, CA (US); Ishaque Ashar Kadampot, San Diego, CA (US); Fatih Murat Porikli, San Diego, CA (US); Max Welling, Bussum (NL)

(21) Appl. No.: 17/804,842

(22) Filed: May 31, 2022

Related U.S. Application Data
(60) Provisional application No. 63/194,323, filed on May 28, 2021.

(51) Int. Cl. G06N 3/08

(52) U.S. Cl. CPC G06N 3/08

(57) ABSTRACT

Certain aspects of the present disclosure provide techniques for training and inferencing with machine learning localization models. In one aspect, a method, includes training a machine learning model based on input data for performing localization of an object in a target space, including: determining parameters of a neural network configured to map samples in an input space based on the input data to samples in an intrinsic space; and determining parameters of a coupling matrix configured to transport the samples in the intrinsic space to the target space.

### CROSS-REFERENCE TO RELATED APPLICATIONS

This Application claims the benefit of and priority to U.S. Provisional Patent Application No. 63/194,323, filed on May 28, 2021, the entire contents of which are incorporated herein by reference.

### INTRODUCTION

Aspects of the present disclosure relate to machine learning for localization.

Machine learning is generally the process of producing a trained model (e.g., an artificial neural network), which represents a generalized fit to a set of training data. Applying the trained model to new data enables production of inferences, which may be used to gain insights into the new data.

While modern machine learning model architectures have achieved significant success for various tasks, such architectures tend to be data-modality specific, which limits their usage to domains with similar, if not identical, input data characteristics. Consequently, advances in machine learning model architectures in one domain are often not applicable to other domains. Because training machine learning models based on such architectures is extremely time and processing intensive, it desirable to have more generally applicable machine learning model architectures.

Localization is generally the task of locating a thing, such as a person or other object, in a space, such as a two- or three-dimensional space. Localization may be performed using many input data modalities, such as using received signal data, image data, and the like. However, machine learning model architectures designed around the localization task tend to be data-modality specific. For example, a model architecture based on video input data generally will not work for input data of a different sensing type, such as wireless signals.

Accordingly, approaches are needed for improving the ability for localization machine learning model architectures to work with varied input data modalities.

### BRIEF SUMMARY

Certain aspects provide a method, comprising: training a machine learning model based on input data for performing localization of an object in a target space, including: determining parameters of a neural network configured to map samples in an input space based on the input data to samples in an intrinsic space; and determining parameters of a coupling matrix configured to transport the samples in the intrinsic space to the target space.

Further aspects provide a method, comprising: processing input data with a trained neural network model to generate a prototype vector output; determining a cluster centroid closest to the prototype vector output; and determining based on the cluster centroid an estimated location of an object associated with the input data in a target space.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example of mapping from an input space manifold to an intrinsic space manifold.

FIG. 2 depicts an example machine learning model training architecture for training localization models.

FIG. 3 depicts example inferencing architectures based on various aspects, described herein.

FIG. 4 depicts an example scenario for training and inferencing using a localization model.

FIG. 5 depicts an example method for training a localization model and inferencing with the localization model.

FIG. 6 depicts an example method for inferencing with a localization model

FIG. 7 depicts an example processing system for training machine learning models to perform localization and for performing localization using the same.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for training machine learning models to perform localization and for performing localization using the same.

Localization has been recognized as a critical task in building different systems, such as the navigation of intelligent agents and surveillance. The localization problem has been studied extensively under several classes of algorithms, such as visual odometry, visual simultaneous localization and mapping (VSLAM), self-localization in videos, geo-positioning, etc. Recent localization methods leveraging advances in neural networks may achieve up to meter-level accuracy in indoor positioning problems. However, conventional methods are highly entangled with the modality of input data, and their generalizability remains problematic. For example, adapting existing visual odometry or VSLAM techniques that rely on camera projection models to other types of sensory systems, like RF or sound sensing, is generally not possible without major modifications to the machine learning model architecture.

Localization of a moving observer (e.g., a robot agent equipped with a camera), people inside a building (e.g., using Wi-Fi signals), and a source of a sound signal (e.g., using microphones) may all be considered variants of the same type of task where the input data modality differs. In contrast to existing ad hoc solutions that are tailored for a particular modality, aspects described herein formulate the localization problem in terms of low-dimensional manifold learning for representing input samples in their intrinsic space and transporting them to a target space (e.g., a topological map) by finding correspondence points. Beneficially then, aspects described herein provide a widely applicable machine learning model training architecture that can be used with different input data modalities. Notably, a significant amount of processing time and power can be saved using aspects described herein because modality specific models need not be trained separately.

Generally, depending on whether input sensory data is collected at the location of a moving observer or not, the localization problem can be categorized into two classes: active or passive. For example, locating a robot agent equipped with a camera or a moving person who carries a network-connected device (e.g., a cell phone connected to Wi-Fi) are two examples of active positioning problems. By contrast, locating a person who does not carry any devices based on RF reflections from his body surface while the person walks through Wi-Fi medium in a building is an example of a passive positioning problem. Beneficially, aspects described herein apply to both active and passive localization problems.

In some examples described herein, the localization task aims to pinpoint the location of an object (e.g., a person, a moving observer, or the like) at various times (e.g., associated with various timestamps) within a target space by analysis of measured input data. Accordingly, unlike conventional methods, such as VSLAM, aspects described herein do not need to build the target space; rather, it is assume to have been given as a prior. One example of a target space is a topological map, which can have different forms. For example, the topological map can be a two-dimensional sketch of a floorplan, an accurate three-dimensional model of a building, or the like.

While an object moves in an environment and visits different locations, sensory input data (e.g., RGB video, depth images, or Wi-Fi channel state information, to name a few examples) encode the two-dimensional location of the object as well as the geometry or photometric information of the environment, depending on the type of sensory system used. Thus, the sensory input data (Xₛ) is measured in a high-dimensional ambient space in [symbol] ⁿ, where n>>2. However, the intrinsic space of the sensory input data that encodes the positional information generally lies in either a two- or three-dimensional space, depending on whether the altitude of the object varies or not (e.g., whether or not a person is on a single-level surface or in a multilevel environment (e.g., a multi-story building). From this perspective, finding a nonlinear transformation between the input data X_{S} and its intrinsic two- or three-dimensional embedding creates a solution for the localization problem.

Although incorporating certain domain-knowledge, like employing a camera projection model for an image sensor or a wave propagation equation for an RF Sensor, reduces the problem of finding the transformation ϕ into a parametric regression problem, the obtained solution in such cases would be inherently modality-specific and thus cannot be generalized to other sensory systems. By contrast, aspects described herein consider the transformation as a parametric map of a neural network between the manifold of data from [symbol] ⁿ into [symbol] ^{m}, where m<n. Notably, while various examples described herein consider the case of m=2 , aspects described herein are valid for higher dimensionality intrinsic spaces, such as for m=3 as well. For example, the case of m=2 may relate to a two-dimensional intrinsic space and m=3 may relate to a three-dimensional intrinsic space.

Generally speaking, representing input data in a lower dimensional space falls into the context of manifold learning methods. For localization purposes, such a dimensionality reduction should preserve the pairwise distances between input samples, which allows for finding their correspondence in a target space, such as on a target topological map. In various examples described herein, the input sample Xₛ and their correspondence points on a target topological map can be found by training a neural network and using an optimal transportation method.

Accordingly, aspects described herein formulate the localization task in the context of manifold learning and optimal transportation. Beneficially, the proposed methods generally make no assumptions about the data modality in use, except the existence of a correlation between object location and sensory data. Making no assumption about the transformation, ϕ, makes aspects described herein modality agnostic and applicable to a large family of sensory systems that can be used for localization task.

### Introduction to Manifold Learning

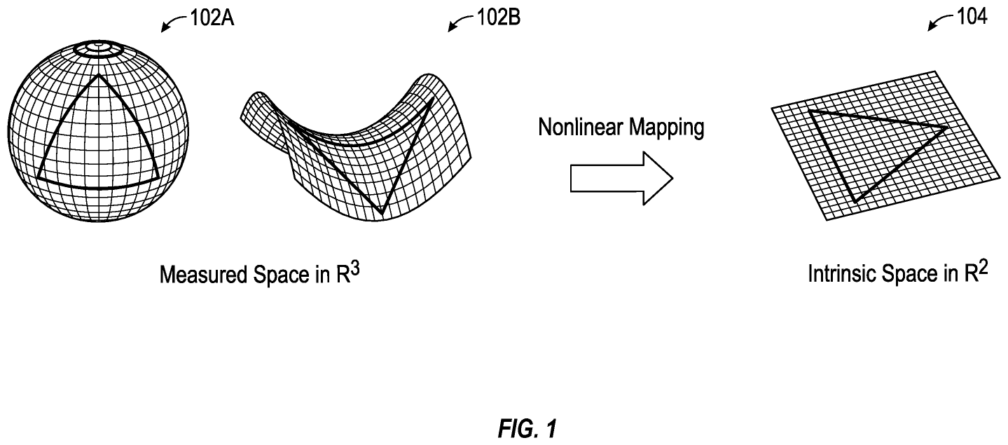

In manifold learning, it is assumed that data points lie on a smooth manifold [symbol] ⊂ [symbol] ⁿ in n-dimensional measured ambient space, such as manifolds 102A or 102B in FIG. 1, and further that data points may be sampled from a distribution on a lower-dimensional sub-manifold [symbol] ⊂ [symbol] ^{m}, where n>m, such as manifold 104. The minimum number of variables needed to describe such a distribution is known as the intrinsic dimensionality, and the task of manifold learning is to find a smooth map Φ: [symbol] → [symbol] from the ambient space to the intrinsic space, such as from manifolds102A or 102B in an ambient three-dimensional space to manifold 104 in a two-dimensional intrinsic space, as depicted in FIG. 1. If the data has intrinsic dimensionality of m, according to the Whitney Embedding Theorem, [symbol] can be embedded smoothly into a dimensionality s=2m using one map, Φ (e.g., a homeomorphism). However, it is often impossible to obtain an isometric embedding directly in the intrinsic space, where an isometric embedding is a smooth embedding that preserves the length of curves. A smooth embedding that preserves the topology of [symbol] might be sufficient for many dimensionality reduction purposes, but when preserving the geometry of the embedding is desirable, finding an isometric embedding is desirable.

### Introduction to Optimal Transportation

When data are associated with geometrical properties, optimal transport metrics (also called Wasserstein distance or Earth Mover distance) measure the spatial variations between probability distributions of source and target domains. Correspondent matching is one example application of optimal transport. Given a transport cost function, the Wasserstein distance computes the optimal transportation plan between two measures. Recent progress on efficient computing of optimal transport by introducing entropy regularization and the Sinkhorn's matrix scaling algorithm reduced the computational cost of optimal transport several orders of magnitude compared to the original transport solver. In particular, it has been shown that computing the optimal transportation loss and its gradient can be tractable by using Sinkhorn fixed-point iterations.

In a localization problem, finding the transformation for representing data points on a given two-dimensional topological map requires knowing a set of correspondence points between an intrinsic space and a target space. By knowing the correspondence points, learning a transformation between an input vector associated with the intrinsic space and a target vector associated with the target space is straightforward. However, in an unsupervised approach, when the correspondences are unknown, estimating this transformation is generally difficult. Thus, in order to find the correspondences between a two-dimensional embedding in the intrinsic space and a target topological map in the target space, the optimal transportation algorithm is employed to find a coupling matrix (e.g., a transport plan) that represents the correspondence between the two domains (two-dimensional embedding in the intrinsic space and the target topological map in the target space in this example). Finding the coupling matrix depends on a parametrized transportation cost that may be computed based on the output of a neural network.

### Modality Agnostic Machine Learning Model Training Architecture for Localization

Aspects described herein formulate a localization problem in the context of manifold learning and optimal transportation. Beneficially, machine learning model training architectures described enable joint and simultaneous learning of an intrinsic embedding from an input space to an intrinsic space, and a transportation mechanism for transporting from the intrinsic space to a target space (e.g., a topological map of an environment) in a weakly-supervised style. Such a joint optimization mitigates the distortion of the intrinsic embedding as the model constrains it to resemble the topology of the target space (e.g., a topological map). The machine learning model training architectures described herein may be optimized using gradient descent.

Notably, the machine learning model architectures described herein do not make any assumption about the data modality in use, which means such architectures are modality-agnostic and can be applied to a large range of sensory systems for localization. Moreover, from the system-setup point of view, the machine learning model architectures described herein are applicable to both active and passive positioning tasks.

In order to define an example localization problem, assume Ωₛ ∈ [symbol] ⁿ is an input space of a measured signal and Ωᵢ ∈ [symbol] ^{m} is its intrinsic space, where it is desirable to represent the discrete samples Xₛ={xᵢ^{s}}ᵢ₌₁^{N}^{ₛ} from Ωₛ. In the localization problem context, the intrinsic dimension (m) is normally equal to 2 or 3, for two-dimensional and three-dimensional localization tasks, respectively.

In one example of the localization problem, a temporal sequence of measured signals may be used as input data Xₛ. It may be assumed that Xₛ lie on a smooth (e.g., Riemannian) manifold in input space Ωₛ and that the manifold is locally connected. This assumption holds since the input data is a temporal sequence of measured signals.

It may also be assumed that a topological map that represents the geometry of the target space Ωₜ is known. This topological map can be, for example, in the form of a two-dimensional sketch, or an accurate Cartesian floorplan of a building, to name just a few example. In some examples, the topological map contains non-convex regions. For example, on a floorplan of a building, there is not necessarily a direct path between every two points on the map since the interior space usually includes walls, doors, furniture, and other obstacles. Notably, the non-convexity of the topological map is problematic when a standard manifold learning technique, such as isometric mapping (or “Isomap,” a nonlinear dimensionality reduction method), approximates the geodesic distances with a Euclidean metric. In the present problem, localizing an object in the topological map (e.g., within the target space Ωₜ requires finding a map between the input space Ωₛ and the target space Ωₜ, without knowing the correspondence points between these two domains.

Using manifold learning techniques, the embedding can be computed in [symbol] ₘ, e.g. (m=2), and a transformation to map the embedding into the target space Ωₜ (for example, the topological map) can be determined. When the correspondence points between the embedding and the target space are unavailable, finding an embedding that preserves the global pairwise distances between samples is desirable to reduce the complexity of the transformation. Thus, methods like Isomap, which preserve the local and global distances, may be preferable. However, it is often impossible to obtain an isometric embedding directly in the intrinsic space Ωᵢ due to the non-convexity of Ωₛ. Usually a severe distortion is imposed on the estimated embedding such that a simple isometric transformation is not sufficient for aligning the intrinsic embedding with the target domain in an unsupervised style. Consequently, it is instead desirable to learn the intrinsic embedding and the transformation jointly without having access to the two-dimensional positions (e.g., (x,y)) of the object on the map, which may not be known. Notably, finding the transformation as a solution of the optimal transport problem and minimizing its cost constrains the topology of the embedding to resemble the target space Ωₜ (e.g., the topological map).

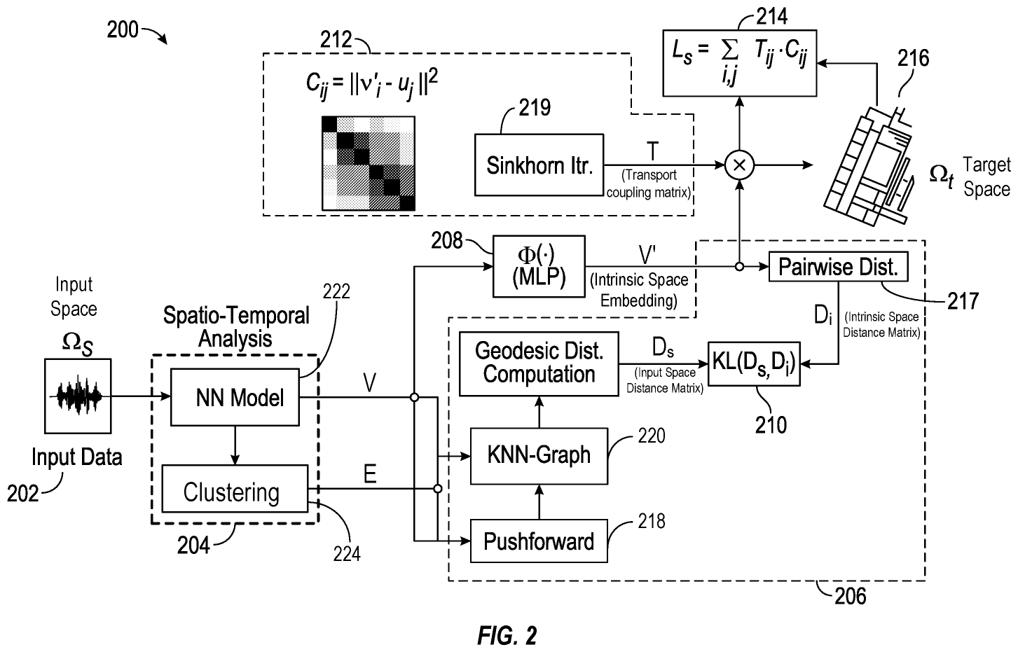

Accordingly, aspects described herein may employ parametric manifold learning and optimal transportation when training machine learning models for localization, wherein the localization problem is formulated as follows. Consider Φ: Ωₛ→Ωᵢ as a smooth map between input space Ωₛ and intrinsic space Ωᵢ. In some aspects, the map Φ can be represented by a neural network, such as an MLP (e.g., as shown in FIG. 2 at 208). In this example, the intrinsic space Ωᵢ ∈ [symbol] ^{m} has the same dimensionality (m=2) as the target space Ωₜ, e.g., the topological map.

Dₛ ∈ [symbol] ^{N}^{ₛ}^{×N}^{ₛ} and Dᵢ ∈ [symbol] ^{N}^{ₛ}^{×N}^{ₛ} are distance matrices between samples in the input space Ωₛ and in the intrinsic space Ωᵢ, respectively. So the entries of Dᵢ can be computed as dᵢⱼ²=∥Φ(xᵢ)−Φ(xⱼ)∥² in one example. Assume, for now, access to the geodesic distance-matrix Dₛ, which contains all pairwise geodesic distances of Xₛ on the input manifold. Below it is explained how the Dₛ can be approximated.

Training the map Φ by minimizing the ∥Dₛ−Dᵢ∥² and using gradient descent optimization, leads to a parametric approximation of the multidimensional scaling (MDS) algorithm. However, this formulation is ill-posed when Xₛ is a non-convex set since comparing the geodesic distances with Euclidean distances by using ∥.∥² (i.e., the L2 norm or root mean-squared error) is only valid inside a convex region. Unfortunately, this is not the case in many real applications, such as indoor localization, where the sample set is, for example, collected from several zones/rooms that are partitioned with walls and other obstacles.

In a localization task, finding the map Φ for representing the input samples in their intrinsic space is not sufficient by itself; a transformation between the embedding in the intrinsic space and the target space Ωₜ (e.g., the target topological map) needs to be found. This can be a challenge since the correspondences between these two domains are unknown. However, the Gromov-Wasserstein discrepancy for measuring the dissimilarity between two distance matrices may be used for solving the correspondence problem. In this sense, the correspondences (coupling) between the entries of two distance matrices are found by performing a regularized optimal transport between these two spaces.

In particular, aspects described herein learn the map Φ to represent the data in the intrinsic space Ωᵢ and simultaneously by finding a coupling matrix (T ∈ [symbol] ^{N}^{ₛ}^{×N}^{ₜ}) to transport the samples from the intrinsic space Ωᵢ to the target space Ωₜ (e.g., a topological map). To do so, an entropy-regularized Wasserstein distance may be used for finding the transport loss between Ωᵢ and Ωₜ. So, training the model consists of minimizing the loss:

$${min}_{Φ , T} L ( {D}_{s} , {D}_{i} ) + {\sum }_{ij} {C}_{ij} . {T}_{ij} , where {C}_{ij} = {‖ ϕ ( {x}_{i} ) - {u}_{j} ‖}^{2} , \qquad ( 1 )$$

where L(Dₛ, Dᵢ) is a dissimilarity measure between the distance matrix in the input space Dₛ and the distance matrix in the intrinsic space Dᵢ, C ∈ [symbol] ^{Ns×Nt} the cost of transporting between the two domains Ωᵢ and Qₜ, T ∈ [symbol] ^{Ns×Nt} is the coupling matrix, Φ(xᵢ) generates an intrinsic space embedding v′, and the second term (the summation) may be referred to as the Sinkhorn distance between the samples in the embedding and the target topological map (u ∈ Ωₜ). As above, choosing the square loss L=∥.∥² is ill-posed since Dₛ contains geodesic distances on the input manifold and the matrix Dᵢ contains L2 distances between samples in the intrinsic space Ωᵢ. Instead, a Kullback-Leibler divergence (KL) may be used for the loss, L.

Accordingly, for minimizing Equation (1), two groups of parameters are involved: the parameters of network (Φ) and the coupling matrix (T). These two groups of parameters can be optimized in an iterative procedure by fixing one and alternating. For example, in one iteration, the Φ can be updated by minimizing L(Dₛ, Dᵢ) and finding a set of samples in embedding Xᵢ by using gradient descent algorithm. In other iteration, the distance between Xᵢ and Xₜ can be used as cost matrix of optimal transportation and then looking for coupling T as a standard optimal transportation problem.

### Regularized Transport with Differentiable Sinkhorn Distance

One major advantage of regularizing the optimal transport problem is that it becomes solvable efficiently using Sinkhorn's algorithm. In computing the entropy constraint of Sinkhorn distance, it is desirable to find a coupling matrix T that satisfies:

$$T ( C , p , q ) = arg min {〈 T , C 〉 -}_{T ∈ γ ( p , q )} \frac{1}{λ} H ( T ) . \qquad ( 2 )$$

In Equation (2), p and q are probability distributions of samples in source (Ωᵢ) and target (Ωₜ) spaces, and γ(p, q) is their joint probability. The C ∈ [symbol] ^{Ns×Nt} is a cost matrix for transporting mass between the two spaces. Hence, in Equation (2),

H(T)=−ΣT.log(T)

is the entropy of coupling T. The solution for Equation (1) is thus:

T(C, p, q)=diag(a).K.diag(b), (3)

where K=e^{-λC} ∈ [symbol] ₊^{N}^{ₛ}^{×N}^{ₜ} is the Gibbs kernel associated with C, and (a, b) ∈ [symbol] ₊^{N}^{ₛ}× [symbol] ₊^{N}^{ₜ} can be computed using the Sinkhorn-Knopp iterative algorithm:

$$a ← \frac{p}{Kb} and b ← \frac{q}{{K}^{T} a} , \qquad ( 4 )$$

where T denotes the transpose of matrix and the division is element-wise. When there is no prior knowledge about the location of the object in an environment, a uniform distribution can be assigned to p and q. In cases where location annotations are provided, a categorical distribution may instead be used. By assuming no prior knowledge, computing the derivative of T with respect to cost matrix C is straightforward. Further, because the cost matrix C depends on Φ, the gradient can be back-propagated to optimize Φ and T jointly.

### Computing the Geodesic Distance on an Input Manifold

The objective function in Equation (1) requires pre-computing the distance matrix Dₛ, which represents the pair-wise distances in the training set Xₛ. Since the Xₛ are on a manifold in input space Ωₛ ∈ [symbol] ⁿ, where n>>2, Euclidean distance (e.g., L2) cannot measure the similarity (e.g., distance) between the samples; instead the pairwise geodesic distance on the manifold should be measured.

In one example, computing the geodesic distance matrix Dₛ in Equation (1), may be performed by (1) reducing the size of Xₛ by finding a set of representative samples (also called prototype vectors or landmarks) and computing their k-nearest neighbors (2) computing a push-forward metric for estimating the Euclidean distances between neighbor prototypes in the embedding; and (3) estimating the pairwise geodesic distances between non-neighbor prototypes, using a shortest path algorithm. Each step is explained in more detail below.

### Finding a Set of Prototypes and Their Nearest Neighbors

In a localization problem, temporal data may contain many samples (e.g., thousands or more). Computing all pairwise distances is thus infeasible. This also introduces a high redundancy in computation as the frequency of sampling is usually several order of magnitude higher than the displacement of an object in the environment. Therefore, it is beneficial to down-sample the data into a relatively smaller set of prototype vectors and only compute the geodesic distances between the prototype vectors.

Generally, the number of prototypes is a trade-off between positioning accuracy and the computational efficiency in the localization context, and this tradeoff can be modulated with a hyperparameter (Nₛ) of the model.

Finding a set of prototypes and their K-nearest neighbors (KNN) in high-dimensional space is challenging. Even for the two-dimensional manifolds in [symbol] ³, such as surfaces with holes or self-intersection, finding the KNN can be erroneous due to short circuiting in three-dimensional space.

Moreover, computing the distances in input ambient space has even higher deficiency when data inherently has some dynamics, such as localization data. For example, when an object revisits the same location, the two recorded samples can look quite different due to many factors, such as rotation of a camera with respect to any of its three axes in a visionary system, or the stochasticity in RF reflections from the object in an RF localization case. This dynamic introduces a large dissimilarity between spatially neighboring samples if the metric space is the input ambient space.

Considering all the sophistication in finding a set of prototype vectors and their neighbors in high-dimensional data, it is possible to learn the metric space by training a neural network on the triplet sampled data. In one example, each triplet set contains two samples that are temporally close and relatively far from the third one. An upper bound may be applied on the far distance that is a hyperparameter of sampling, based on some physical constraints on the movement of the object in the space. Thus, by minimizing its triplet margin loss, the network learns to produce similar feature vectors for samples based on their temporal vicinity. After training the network, K-means clustering may be applied to generate Nₛ clusters, where the centroid of each of the K clusters represents a prototype vector. Consequently, the K nearest neighbors of each prototype vector can be performed by measuring its L2 distance in the feature space of the network, such as performed at 220 in FIG. 2.

In one aspect, learning a metric space for computing both the prototype vectors and their neighbor indices is performed by training a neural network on the triplet sampled data. Each triplet set contains two samples that are temporally close, and a third one that is distant. An upper bound may be applied to the maximal temporal distance, and the network learns to produce similar feature vectors for samples, based on their temporal vicinity by minimizing its triplet margin loss according to:

L=max(0, d(hᵢ^{a}, hᵢ^{p})−d(hᵢ^{a}, hᵢⁿ)+α) wherein hᵢ=Ψ(xᵢ).

In the preceding equation, the symbol Ψ denotes the function of the neural network, d is L2 norm, and (hᵢ^{a}, hᵢ^{p}, hᵢⁿ ∈ [symbol] ^{v}, v<n), are the output vectors of the network, produced from the ith set of anchor, positive and negative instances, and the scalar α is a constant margin. After convergence, the data samples (Xₛ) are partitioned into Nₛ clusters by applying a k-means clustering on the obtained features set h. The centroid vectors of each class is used as the prototype. Furthermore, by measuring the pairwise Euclidean distances between the feature set, the K-nearest neighbors of each prototype are found.

### Approximating the Push-Forward Metric

In order to compute the distance matrix Dₛ that represents pair-wise distances in embedding Ωᵢ, the map Φ is required. However, the map Φ that is implemented by a neural network is not available prior to training the network. According to differential geometry, approximating the map between the tangent space of input space Ωₛ and intrinsic space Ωᵢ may be performed by the push-forward method, such as depicted at 218 in FIG. 2. Based on this approximation, if the input data Xₛ are considered to lie on a smooth (Riemannian) manifold in Ωₛ , the tangent vector can be transferred to the embedding Ωᵢ by:

∥Φ(xᵢ)−Φ(xⱼ)∥₂≈1/2[xᵢ−xⱼ]^{T}·[C^{†}(xᵢ)+C^{†}(xⱼ)]·[xᵢ−xⱼ], (5)

where C(xᵢ) is the measured local covariance matrix of data at the location of sample xᵢ, and † denotes the Moore-Penrose pseudoinverse. Since, the input samples are clustered into Nₛ clusters, each associated with a prototype vector, the covariance of samples can be computed for each cluster. When the distances are small enough, such an estimation is similar to the pushforward in differential geometry that is an approximation to the smooth map between tangent spaces of two manifolds. Consequently, Equation (5) can estimate the distances between nearest neighbor prototypes in the intrinsic space.

After computing all pairwise distances between each prototype and its KNN, a KNN-graph (e.g., 220 in FIG. 2) is crated and the distances between non-neighboring samples are estimated by using, for example, the Dijkstra's shortest path algorithm. Then, the geodesic matrix Dₛ in the embedding space is known and Equation (1) can be evaluated for training the model.

### Example Machine Learning Model Training Architecture for Localization

FIG. 2 depicts an example training architecture 200 based on various aspects, described herein.

Initially, input data 202 (Xₛ) in the input space Ωₛ is analyzed by spatio-temporal analysis component 204 to generate prototype vectors V_{N×v} and edges E_{N×k} of a nearest neighbor graph. In one example, input data 202 comprises data related to a wireless medium, such as Wi-Fi channel state information. In the depicted example, a neural network model 222 is used to generate the prototype vectors V_{N×v}. In some aspects, neural network model 222 is a convolutional neural network model. Neural network model 222 is used to minimize the triplet-margin loss, discussed above, and then the output of neural network model 222 is clustered by clustering component 224 (e.g., using K-means). The K nearest neighbors may be determined from the clusters (and the associated cluster centroids) generated by clustering component 224.

These outputs of the spatio-temporal analysis component 204 are provided to a map 208 (Φ) configured to map between input space Ωₛ and intrinsic space Ωᵢ, e.g., Φ:Ωₛ→Ωⱼ. As above, in some examples, map 208 may be implemented as a multi-layer perceptron (MLP) model, such as a two-layer perceptron neural network. The output of map 208 is an embedding in the intrinsic space V′_{N×2}, which is used for calculating pairwise distances 217 between prototypes in the intrinsic space Ωᵢ, such as in a distance matrix Dᵢ.

A distance matrix Dₛ associated with the input space Ωₛ, which records geodesic distances between samples Xₛ in the input space Ωₛ, may be estimated using the push-forward technique and K-nearest neighbors as described above, as depicted in distance comparison component 206. Accordingly, the output of the spatio-temporal analysis at 204 are also provided to distance comparison component 206 in order to prepare a geodesic distance matrix calculation.

The distance matrix associated with the intrinsic space Dᵢ can be compared to a distance matrix associated with the input space Ωₛ using a Kullback-Leibler (KL) divergence to generate a dissimilarity loss component at matrix dissimilarity loss component 210. Training the model architecture involves determining parameters that minimize this dissimilarly loss component, as in the first component of Equation (1), above.

The prototype vectors mapped to the intrinsic space can be transported to the target space Ωₜ, which in this example is topological map 216, via a transport coupling matrix (T_{N×N}_{ₜ}) determined via a Sinkhorn-Knopp iterative algorithm 219 at transportation component 212, as described above.

Finally, a transportation loss Lₛ may be computed at 214 based on the Sinkhorn distance between samples in the intrinsic space Ωᵢ and the target space Ωₜ according to Equation 1, above.

Thus, as described above, training model architecture 200 simultaneously learns the map 208 (Φ) to represent the data in the intrinsic space Ωᵢ and the coupling matrix (T ∈ [symbol] ^{N}^{ₛ}^{×N}^{ₜ}) to transport the samples from the intrinsic space Ωᵢ to the target space Ωₜ (a topological map in this example).

### Example Machine Learning Model Architecture for Localization

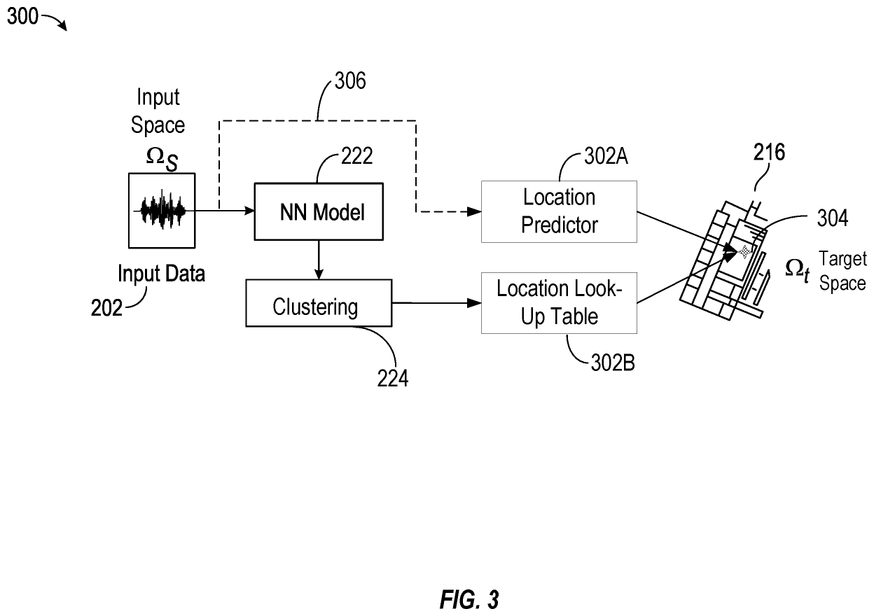

FIG. 3 depicts example inferencing architectures 300 based on various aspects, described herein. For example, flow 300 may be performed after training a model according to architecture 200 described with respect to FIG. 2.

Generally, FIG. 3 depicts two alternative inferencing strategies. In a first alternative, a new location predictor model 302A may be trained based on the data created during the training according to flow 200 described with respect to FIG. 2, which includes input data 202 and ultimately samples transported to the target space 216. In other words, after training according to flow 200, the correspondences between all training samples and a set of 2D points on the target space 216 floorplan are known. This set of points can be used as pseudo labels to train location predictor 302A in a supervised fashion. Once trained, location predictor 302A may receive input data directly (e.g., as depicted by broken line 306) and predict their locations (and zone labels) in target space 216, such as location 304. In some aspects, location predictor model 302A may be implemented as a convolutional neural network model.

In a second alternative, input data 202 may be provided to the neural network model 222 trained as a part of flow 200. The output of neural network model 222 (e.g., an embedding vector) may be clustered, and the clustering output (e.g., a centroid associated with the embedding vector) may be used to identify and assign a location 304 in the target space (topological map 216 in this example). For example, look-up table 302B may be used to map the output from clustering component 224 (e.g., cluster centroids and/or cluster entities) to topological map 216. The look-up table 302B may include, for example, coordinates as well as zone labels for the inferred location. In this way, look-up table 302B effectively replaces the trained map 208 and the transport component 212 in FIG. 2.

Note that while two different implementations are depicted (one using location predictor 302A and one using location look-up table 302B, only one implementation would generally be needed in practice.

### Example Application: Training a Model for Passive Wi-Fi Localization

One use for a model trained according to aspects described above is localization of a moving target in a pervasive Wi-Fi environment, such as a home, office building, airport, and the like. Notably, when a tracked object (e.g., a person) does not carry any device, like a cellphone, the only source of information for localizing the person is the reflections of the transmitted electromagnetic waves from the body of the moving object.

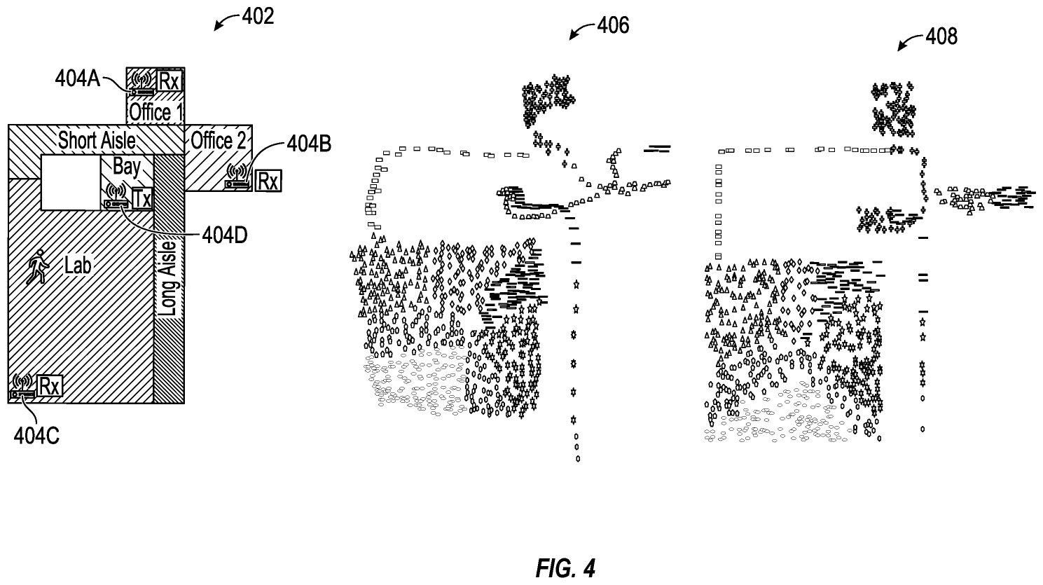

FIG. 4 depicts an example scenario in which multiple access points 404A-D, operating in the 2.4 GHz and/or 5 GHz bands, are deployed in a space within a building, which is represented by a topological map 402. In this example, the environment contains three rooms, two long aisles, and a large lab, each of which may be referred to as a “zone label” for a particular zone of topological map 402. Each of the three receiving access points 404A-C may be configured to use multiple antennas (e.g., 2, 4, 8, or another number of antennas), while the transmitting access point 404D is configured to use a single transmit antenna.

Each receiving access point 404A-C collects Channel State Information (CSI) at periodic intervals, which represents the state of the channel between the transmitter antenna and each of its receiving antennas, across a plurality of frequency tones that span the transmission bandwidth. For example, where each receiving access point 404A-C uses eight receiving antennas, and there are 208 tones in the transmission bandwidth, the CSI data may be represented as a multidimensional tensor of complex numbers of dimension 8×1×208 per each packet. In some examples, the magnitude of CSI signals may be used.

For data collection, CSI data from the three receiving access points 404A-C, is collected while a person (e.g., tracked object) freely walks through different locations in the environment.

The plot 406 indicates the ground-truth position of the person walking through the environment, and plot 408 indicates the position in the target space (which may then be projected onto a topological map of the environment, such as 402) generated by a machine learning model (e.g., an inference) trained according to the architecture described with respect to FIG. 2. In plots 406 and 408 of FIG. 4, different symbols are used to indicate correspondence between different sets of locations. Notably, the average error between ground truth and predicted positions is relatively small. Notably, the outputs generated by plot 408 may be examples of outputs described with respect to the inferencing flow 300 in FIG. 3.

In some cases, before processing the CSI data in the machine learning model architecture, a number of digital signal processing (DSP) techniques may be used to preprocess the raw signal. Thus, in another example, after preprocessing and filtering of the raw CSI, the magnitude of CSI data can be represented with a multi-dimensional tensor of size n×h×c×rx×tx, where n is a number of packets during recording time (typically 100-300 packets per second), h is a number of devices acting as receivers (for example three), c is a number of subcarriers in an orthogonal frequency division multiplexing (OFDM) communication protocol (typically 52 or 242), tx is a number of antennas of the transmitter device (typically 1 or 4 or 8), and rx is a number of antennas of each of the receivers (typically 4 or 8).

### Example Training Procedures by End Users

In some cases, a user may be involved in generating training data in order to train a machine learning model for localization, such as described above.

In one example, a user may deploy a Wi-Fi mesh (e.g., with 2 or more mesh points) and deploy it in a home. With the Wi-Fi mesh active, the user visits all the rooms in the house and uses an application on a mobile device (e.g., on a smartphone, tablet, or similar) to provide real-time room labels (e.g., kitchen, living room, home office, and the like). With just this data, the model architecture described above (e.g., with respect to FIG. 2) may be trained to perform room-level localization. Further, the user may in some cases use the application to provide a sketch of the house and the location of the mesh points. With this additional information, the trained model can do precise localization within each room. This is an example of passive indoor positioning.

In another example, the aforementioned procedure is modified by the user connecting the mobile device to the Wi-Fi mesh network so that the network take active measurements of the location of the mobile device while the user traverses the environment. This is an example of active indoor positioning.

### Example Methods for Training a Localization Model

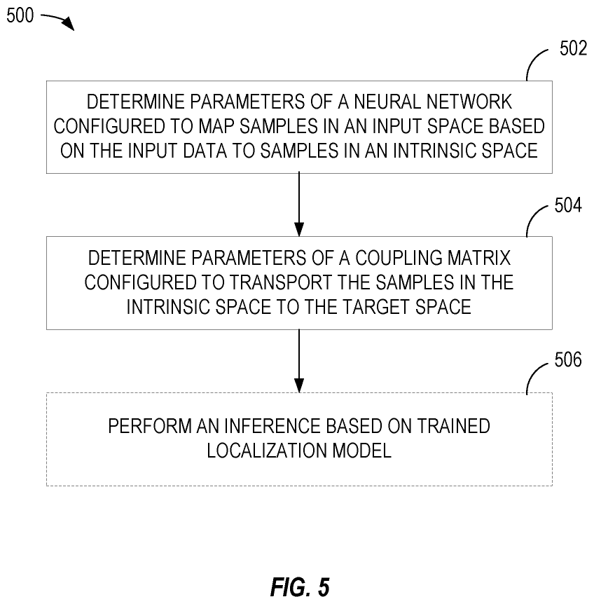

FIG. 5 depicts an example method 500 for training a localization model.

The method 500 begins at step 502 with determining parameters of a neural network configured to map samples in an input space based on the input data to samples in an intrinsic space. In some aspects, the neural network comprises a multi-layer perceptron like model 208 in FIG. 2.

In some aspects, determining parameters of the neural network configured to map samples in the input space based on the input data to samples in the intrinsic space comprises minimizing a difference between a distance matrix associated with the input space and a distance matrix associated with the intrinsic space.

In some aspects, minimizing a difference between the distance matrix associated with the input space and the distance matrix associated with the intrinsic space comprises minimizing a dissimilarity measure between the distance matrix associated with the input space and the distance matrix associated with the intrinsic space via an optimal transport coupling matrix. In some aspects, the dissimilarity measure comprises a Gromov-Wasserstein discrepancy measure.

In some aspects, the distance matrix associated with the input space is determined by: computing a push-forward metric; determining a set of prototype vectors based on training data; determining, for each respective prototype vector in the set of prototype vectors, the K-nearest neighboring prototype vectors to the respective prototype vector; and computing a shortest path distance between the set of prototype vectors, as described above with respect to FIG. 2. The shortest path computations may be used to generate a distance matrix (e.g., geodesic distance) in the embedding space, Dₛ, as described above.

The method 500 then proceeds to step 504 with determining parameters of a coupling matrix configured to transport the samples in the intrinsic space to a target space. For example, the coupling matrix may be T as in FIG. 2.

In some aspects, determining parameters of the coupling matrix comprises performing a Sinkhorn-Knopp iterative algorithm, such as performed by transportation component 212 in FIG. 2.

In some aspects, training the machine learning model for performing localization of the object in the target space, further includes minimizing a loss function based on an entropy-regularized Wasserstein distance for finding a transportation loss between the intrinsic space and the target space. In some aspects, the loss function is Equation (1), above.

In some aspects, the object is a person, the target space is a topological map, and the input data is Wi-Fi channel state information, such as described above with respect to FIG. 4.

In some aspects, method 500 optionally proceeds to step 506 with performing an inference based on the trained localization model. For example, an inference may be performed as described with respect to FIG. 3.

Note that FIG. 5 is just one example of a method, and other methods including fewer, additional, or alternative steps are possible consistent with this disclosure.

### Example Method for Inferencing with a Localization Model

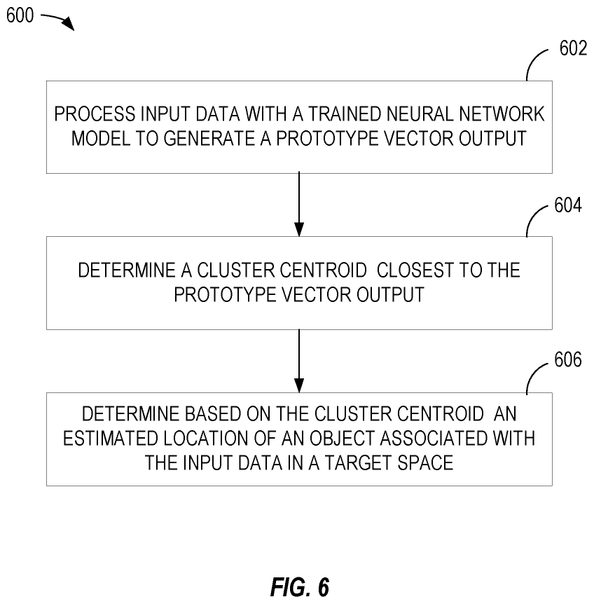

FIG. 6 depicts an example method 600 for inferencing with a localization model, such as a model trained according to method 500 described with respect to FIG. 5. In some aspects, inferencing architectures 300 described with respect to FIG. 3 may be used to perform method 600.

Method 600 begins at step 602 with processing input data with a trained neural network model to generate a prototype vector output.

Method 600 then proceeds to step 604 with determining a cluster centroid closest to the prototype vector output.

Method 600 then proceeds to step 606 with determining based on the cluster centroid an estimated location of an object associated with the input data in a target space.

In some aspects, the trained neural network comprises a convolutional neural network, and the input data comprises Wi-Fi channel state information.

In some aspects, determining based on the cluster centroid the estimated location of the object associated with the input data in the target space comprises determining the location based on a look-up table storing a plurality of estimated locations in the target space associated with a plurality of cluster centroids.

In some aspects, the target space comprises a topological map.

In some aspects, the object is a person.

Note that FIG. 6 is just one example of a method, and other methods including fewer, additional, or alternative steps are possible consistent with this disclosure.

### Example Processing System

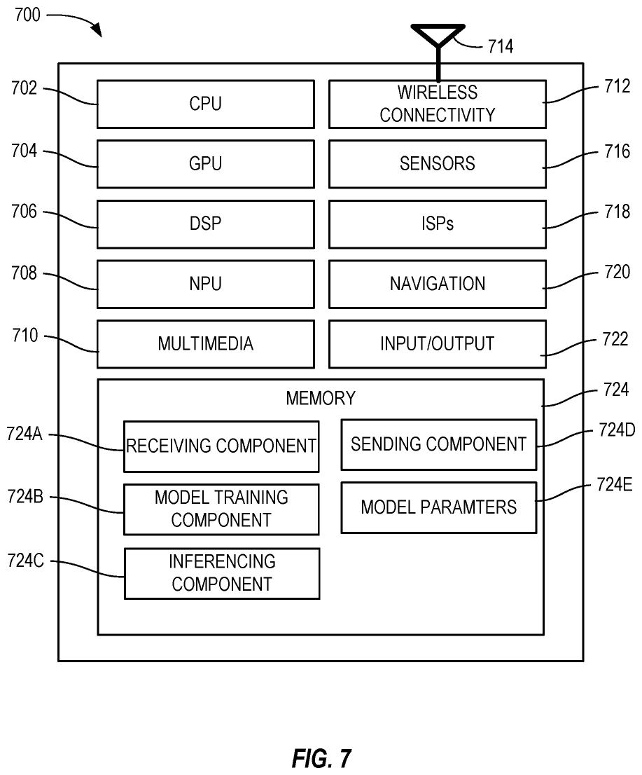

FIG. 7 depicts an example processing system 700 for training machine learning models to perform localization and for performing localization using the same, such as described herein for example with respect to FIGS. 2-6.

Processing system 700 includes a central processing unit (CPU) 702, which in some examples may be a multi-core CPU. Instructions executed at the CPU 702 may be loaded, for example, from a program memory associated with the CPU 702 or may be loaded from a memory partition 724.

Processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as 708, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 708 is a part of one or more of CPU 702, GPU 704, and/or DSP 706.

In some examples, wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 712 is further connected to one or more antennas 714.

Processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes receiving component 724A, model training component 724B, inferencing component 724C, sending component 724D, and model parameters 724E. The depicted components, and others not depicted, may be configured to perform various aspects of the methods described herein.

Generally, processing system 700 and/or components thereof may be configured to perform the methods described herein, such as method 500 and 600 of FIGS. 5 and 6, respectively.

Notably, in other cases, aspects of processing system 700 may be omitted, such as where processing system 700 is a server computer or the like. For example, multimedia component 710, wireless connectivity 712, sensors 716, ISPs 718, and/or navigation component 720 may be omitted in other aspects. Further, aspects of processing system 700 maybe distributed between multiple devices.

Notably, processing system 700 is just one example, and others are possible.

### Example Clauses

Implementation examples are described in the following numbered clauses:

Clause 1: A computer-implemented method, comprising: processing input data with a trained neural network model to generate a prototype vector output; determining a cluster centroid closest to the prototype vector output; and determining based on the cluster centroid an estimated location of an object associated with the input data in a target space.

Clause 2: The method of Clause 1, wherein: the trained neural network comprises a convolutional neural network, and the input data comprises Wi-Fi channel state information.

Clause 3: The method of any one of Clauses 1-2, wherein determining based on the cluster centroid the estimated location of the object associated with the input data in the target space comprises determining the location based on a look-up table storing a plurality of estimated locations in the target space associated with a plurality of cluster centroids.

Clause 4: The method of any one of Clauses 1-3, wherein the target space comprises a topological map.

Clause 5: The method of any one of Clauses 1-4, wherein the object is a person.

Clause 6: A method, comprising: training a machine learning model based on input data for performing localization of an object in a target space, including: determining parameters of a neural network configured to map samples in an input space based on the input data to samples in an intrinsic space; and determining parameters of a coupling matrix configured to transport the samples in the intrinsic space to the target space.

Clause 7: The method of Clause 6, wherein determining parameters of the neural network configured to map samples in the input space based on the input data to samples in the intrinsic space comprises minimizing a difference between a distance matrix associated with the input space and a distance matrix associated with the intrinsic space.

Clause 8: The method of Clause 7, wherein minimizing a difference between the distance matrix associated with the input space and the distance matrix associated with the intrinsic space comprises minimizing a dissimilarity measure between the distance matrix associated with the input space and the distance matrix associated with the intrinsic space via an optimal transport coupling matrix.

Clause 9: The method of Clause 8, wherein the dissimilarity measure comprises a Gromov-Wasserstein discrepancy measure.

Clause 10: The method of any one of Clauses 7-9, further comprising determining the distance matrix associated with the input space by: computing a pushforward metric; determining a set of prototype vectors based on training data; determining, for each respective prototype vector in the set of prototype vectors, K-nearest neighboring prototype vectors to the respective prototype vector; and computing a shortest path distance between the set of prototype vectors.

Clause 11: The method of any one of Clauses 6-10, wherein determining parameters of the coupling matrix comprises performing a Sinkhorn-Knopp iterative algorithm.

Clause 12: The method of any one of Clauses 6-11, wherein training the machine learning model for performing localization of the object in the target space, further includes minimizing a loss function based on an entropy-regularized Wasserstein distance for finding a transportation loss between the intrinsic space and the target space.

Clause 13: The method of any one of Clauses 6-12, wherein the neural network comprises a multi-layer perceptron.

Clause 14: The method of any one of Clauses 6-13, wherein: the object is a person, the target space comprises a topological map, and the input data is Wi-Fi channel state information.

Clause 15: The method of any one of Clauses 6-14, further comprising performing an inference based on the trained machine learning model.

Clause 16: A processing system, comprising: a memory comprising computer-executable instructions; and a processor configured to execute the computer-executable instructions and cause the processing system to perform a method in accordance with any one of Clauses 1-15.

Clause 17: A processing system, comprising means for performing a method in accordance with any one of Clauses 1-15.

Clause 18: A non-transitory computer-readable medium comprising computer-executable instructions that, when executed by one or more processors of a processing system, cause the processing system to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
processing input data with a trained neural network model to generate a prototype vector output;
determining a cluster centroid closest to the prototype vector output; and
determining based on the cluster centroid an estimated location of an object associated with the input data in a target space.

2. The method of claim 1, wherein:
the trained neural network comprises a convolutional neural network, and
the input data comprises Wi-Fi channel state information.

3. The method of claim 1, wherein determining based on the cluster centroid the estimated location of the object associated with the input data in the target space comprises determining the location based on a look-up table storing a plurality of estimated locations in the target space associated with a plurality of cluster centroids.

4. The method of claim 1, wherein the target space comprises a topological map.

5. The method of claim 1, wherein the object is a person.

6. A method, comprising:
training a machine learning model based on input data for performing localization of an object in a target space, including:
determining parameters of a neural network configured to map samples in an input space based on the input data to samples in an intrinsic space; and
determining parameters of a coupling matrix configured to transport the samples in the intrinsic space to the target space.

7. The method of claim 6, wherein determining parameters of the neural network configured to map samples in the input space based on the input data to samples in the intrinsic space comprises minimizing a difference between a distance matrix associated with the input space and a distance matrix associated with the intrinsic space.

8. The method of claim 7, wherein minimizing a difference between the distance matrix associated with the input space and the distance matrix associated with the intrinsic space comprises minimizing a dissimilarity measure between the distance matrix associated with the input space and the distance matrix associated with the intrinsic space via an optimal transport coupling matrix.

9. The method of claim 8, wherein the dissimilarity measure comprises a Gromov-Wasserstein discrepancy measure.

10. The method of claim 7, further comprising determining the distance matrix associated with the input space by:
computing a pushforward metric;
determining a set of prototype vectors based on training data;
determining, for each respective prototype vector in the set of prototype vectors, K-nearest neighboring prototype vectors to the respective prototype vector; and
computing a shortest path distance between the set of prototype vectors.

11. The method of claim 6, wherein determining parameters of the coupling matrix comprises performing a Sinkhorn-Knopp iterative algorithm.

12. The method of claim 6, wherein training the machine learning model for performing localization of the object in the target space, further includes minimizing a loss function based on an entropy-regularized Wasserstein distance for finding a transportation loss between the intrinsic space and the target space.

13. The method of claim 6, wherein the neural network comprises a multi-layer perceptron.

14. The method of claim 6, wherein:
the object is a person,
the target space comprises a topological map, and
the input data is Wi-Fi channel state information.

15. The method of claim 6, further comprising performing an inference based on the trained machine learning model.

16. A processing system, comprising:
a memory comprising computer-executable instructions; and
a processor configured to execute the computer-executable instructions and cause the processing system to:
process input data with a trained neural network model to generate a prototype vector output;
determine a cluster centroid closest to the prototype vector output; and
determine based on the cluster centroid an estimated location of an object associated with the input data in a target space.

17. The processing system of claim 16, wherein:
the trained neural network comprises a convolutional neural network, and
the input data comprises Wi-Fi channel state information.

18. The processing system of claim 16, wherein in order to determine based on the cluster centroid the estimated location of the object associated with the input data in the target space, the processor is further configured to cause the system to determine the location based on a look-up table storing a plurality of estimated locations in the target space associated with a plurality of cluster centroids.

19. The processing system of claim 16, wherein the target space comprises a topological map.

20. The processing system of claim 16, wherein the object is a person.

21. A processing system, comprising:
a memory comprising computer-executable instructions; and
a processor configured to execute the computer-executable instructions and cause the processing system to:
train a machine learning model based on input data for performing localization of an object in a target space, including:
determine parameters of a neural network configured to map samples in an input space based on the input data to samples in an intrinsic space; and
determine parameters of a coupling matrix configured to transport the samples in the intrinsic space to the target space.

22. The processing system of claim 21, wherein in order to determine parameters of the neural network configured to map samples in the input space based on the input data to samples in the intrinsic space, the processor is further configured to cause the system to minimize a difference between a distance matrix associated with the input space and a distance matrix associated with the intrinsic space.

23. The processing system of claim 22, wherein in order to minimize a difference between the distance matrix associated with the input space and the distance matrix associated with the intrinsic space, the processor is further configured to cause the system to minimize a dissimilarity measure between the distance matrix associated with the input space and the distance matrix associated with the intrinsic space via an optimal transport coupling matrix.

24. The processing system of claim 23, wherein the dissimilarity measure comprises a Gromov-Wasserstein discrepancy measure.

25. The processing system of claim 22, wherein in order to determine the distance matrix associated with the input space, the processor is further configured to cause the system to:
compute a pushforward metric;
determine a set of prototype vectors based on training data;
determine, for each respective prototype vector in the set of prototype vectors, K-nearest neighboring prototype vectors to the respective prototype vector; and
compute a shortest path distance between the set of prototype vectors.

26. The processing system of claim 21, wherein in order to determine parameters of the coupling matrix, the processor is further configured to cause the system to perform a Sinkhorn-Knopp iterative algorithm.

27. The processing system of claim 21, wherein in order to train the machine learning model for performing localization of the object in the target space, the processor is further configured to cause the system to minimize a loss function based on an entropy-regularized Wasserstein distance for finding a transportation loss between the intrinsic space and the target space.

28. The processing system of claim 21, wherein the neural network comprises a multi-layer perceptron.

29. The processing system of claim 21, wherein:
the object is a person,
the target space comprises a topological map, and
the input data is Wi-Fi channel state information.

30. The processing system of claim 21, wherein the processor is further configured to cause the system to perform an inference based on the trained machine learning model.
